(19) United States
(12) Patent Application Publication
(10) Pub. No.: US 2005/0211392 A1
(43) Pub. Date: Sep. 29, 2005

(54) Window curtain covering

(76) Inventor: Ismail Abdel-monem Elembaby, Holtsville, NY (US)

Correspondence Address: ISMAIL A. ELEMBABY, 2 BLACKPINE CT., HOLTSVILLE, NY, 11742, US

(21) Appl. No.: 11/079,067

(22) Filed: Mar. 14, 2005

Related U.S. Application Data
(60) Provisional application No. 60/557,448, filed on Mar. 29, 2004.

(51) Int. Cl. E06B 3/32

(52) U.S. Cl. 160/89

(57) ABSTRACT

A decorative window curtain covering comprising a combination of semi opaque or opaque material and translucent or transparent material for the achievement of a variety of different decorative and translucency effects. The combination of the material arranged of a series of parallel regularly spaced louvers of semi opaque or opaque material and back wall sections of transparent or translucent material, said louvers extended vertically and being pivotally mounted to a conventional horizontal track used for vertical blinds, so that when the curtain is open forms a continuous assembly of alternatingly semi opaque or opaque louvers and transparent or translucent curtain wall sections. Which permitting the transmission of light through the curtain wall sections to the room, and when the curtain is closed the louvers which are made of opaque fabric overlap each other and substantially block the transmission of light through to the room, or when the louvers are made of semi opaque fabric it will decrease the transmission of light through the room.

### BACKGROUND OF THE INVENTION

1. Field of the Invention

The present invention relates to window coverings and more particularly to those that fold like conventional curtain assembly, but including in combination a semi opaque or opaque flexible material and transparent or translucent material.

2. Description of the Prior Art

In U.S. Pat. No. 3,844,330 issued in 1974 to louver Drape. Inc. there is disclosed a window covering system using conventional vertical blind hardware employed with vertically disposed louvers according to this 330 patent, the window covering made of one kind of continuous material, thus does not achieve the variety of colors and different, decorative and translucent effects, also in order to achieve the decorative effects, this disposed louver system must positioned behind a separate drapery system, or associated with drapers, the drapery material may be pinch pleated and attached at the front of each louver.

U.S. Pat. No. 3,851,699 issued in 1974 to Shapiro discloses a vertical louver type window drape where a continuous sheet of fabric material is interwoven with a plurality of relatively rigid vanes such that the vanes which are light impeding alternate with light transmitting sections of the fabric. One obvious drawback of a system of this type is that the vanes overlap the fabric requiring excessive fabric in order to fabricate the entire window covering.

Window coverings of the afore—no ted type as mentioned previously are desirable from several viewpoints. It has also been discovered that variation in this general type of window covering may be desirable from many stand points, both utilitarian and aesthetic. But none of them offered to use two different types of fabric material in one window covering assembly. It is to provide alternatives and improvements to the afore described prior art systems that the present window curtain has been developed.

Fabric window coverings are often preferred by consumers for a number of their features. Features most often considered desirable are the softer appearance relative to traditional Venetian blinds, the uniform appearance which they provide a window and insulating properties associated with cellular fabric shades.

Cellular fabric shades offering these features are known in the art. For example, U.S. Pat. No. 4,450,027 to Colson discloses cellular window coverings which may be made of fabric or fill materials. In the process disclosed in the Colson patent, a flexible strip of material is folded into a continuous longitudinal tube and the longitudinal folds thus created are currently set by passing the tubing material around a heat setting wheel. Adhesive is applied along one side of the flattened tubular material which is subsequently stacked by winding onto a rack having flat surfaces. The winding in this manner presses the adhesive to the next layer wound onto the rack to form a bonded unitary stack of closed tubular cells. When the ends are cut from the rack, the stack may be expanded and the permanently set creases provide a neat and uniform outward appearance.

U.S. Pat. No. 4,732,630 to Schnebley discloses a modification to the Colson process described above. In the Schnebley patent, a hot melt adhesive is applied to one side of the tubular material. After the flat tubular strips have been stacked and cut, they are placed in an oven under pressure and the hot melted adhesive is activated to bond the layers together.

Both of the above patents disclose window coverings which exhibit the desirable features discussed to this point. However, window coverings of that type lack one feature which is often desired by consumers. That feature is the ability to control the amount of light admitted through the window covering, similar to a traditional Venetian blind. There have been some attempts to provide a fabric window covering with the ability to control the amount of light entering the room.

### OBJECTS OF THE INVENTION

It is therefore a general object of this invention is to provide alternative and improvements to this type of window covering.

A primary object of the present invention is to provide two different types of flexible fabric material in combination, first type is semi opaque or opaque fabric formed of plurality of vertical louvers and a second type is transparent or translucent fabric arranged to serve as back wall sections for the louvers.

Yet another object of the present invention is the provision of a window curtain which combines the desirable characteristics of both a louver type vertical blind and a conventional window drape, affording the adjustable light transmission features of a vertical blind while retaining the esthetic characteristics of a conventional window drape.

Still yet another object of the present invention is to provide a window curtain consisting of a plurality of vertical louvers having variety of colors and or designs.

Still yet another object of the present invention is that the louvers could be vertically suspended by carriers of any kind of vertical blind tracks with a control system that enables the louvers to be pivoted between an open position where in they extend substantially perpendicularly to the back wall section and closed position where in they extend substantially parallel to the back wall section, and to be drawn across the window.

Still another object of the present invention is to replace the existing vertical blind slats, vanes and louvers with the new invention of the curtain assembly without having to change the existing track which is already installed.

Additional objects of the present invention will appear as the description proceeds. The description reference is made to the accompanying drawings, which forms apart here of, and in which is shown by way of illustration specific embodiments in which the invention may be practiced. It is to be understood that other embodiments may be utilized and that structural changes may be made without departing from the scope of the invention. In the accompanying drawing, like reference characters, designate the same or similar parts throughout the several views.

The following detailed description is, therefore, not to be taken in a limiting sense and the scope of the present invention is best defined by the appended claims.

### SUMMARY OF THE INVENTION

In accordance with the teaching of the present invention, there is disclosed in combination of integral series of parallel regularly spaced louvers made of semi opaque or opaque flexible material and a sheet of transparent or translucent material serve as back wall section. Each louver is formed with a single loop and each loop having a pocket. Louvers are horizontally spaced a part a pre-selected distance and being attached to the back wall section along vertical seams and or material fasteners. The louvers being adapted to hang forwardly from the curtain wall sections, thus defining a curtain assembly formed of a continuous assembly of alternating semi opaque or opaque louvers and transparent or translucent curtain wall sections.

Louvers having a means attached to the inner of the top portion of their pockets except for a small opening at about the central of top edge of each pocket to accommodate a means for hanging the louvers. The louvers extended vertically and being pivotally mounted to a horizontal track having a plurality of sliding carriers connected to the louvers which can pivot the louvers about longitudinal vertical axis from open position to a close position, and can traverse the louvers to the side (retracted position).

### BRIEF DESCRIPTION OF THE DRAWINGS

FIGS. 1 through 5 shows schematic plan views of lopped curtain louvers of a first embodiment in accordance with the present invention, in an open, half open, another half open, closed and retracted positions respectively.

FIG. 6 shows an oblique diagram of the present invention of FIGS. 1 through 5 in the open position.

FIG. 7 shows an oblique diagram of the present invention of FIGS. 1 through 5 in the closed position.

FIG. 8 is a fragmentary section of a rear view showing stitches running longitudinally from behind the transparent material along the length of the overlapping portions with the semi opaque fabric.

FIG. 9 is a fragmentary isometric view showing two adjacent louvers in open position and being attached to the transparent material strip along vertical seams.

FIG. 10 is a fragmentary isometric view similar to FIG. 9 with the louvers in a retracted position.

FIG. 11 is a fragmentary section showing a means made of thin strip of plastic that forms a loop with opposed faces, each face having a hole in about the central of it.

FIG. 12 is a fragmentary section showing a louver hung vertically from a hook adapted to extend downwardly from a sliding carrier (not showing).

FIG. 13 is a fragmentary section showing a louver hung vertically from a hook, the bottom part of the hook along with the means of thin strip of plastic being hidden in the pocket of the louver.

FIGS. 14 through 16 are front elevational views of the curtain assembly hung on horizontal track mounted on a vertical wall over a window from open, closed and retracted positions respectively.

FIG. 17 is a perspective view of a material fastener.

FIG. 18 is an end elevational view there of from the top end, the bottom end elevational view being a mirror image there of;

FIG. 19 shows a top side view of the opposed faces of the louvers along with the curtain wall section secured within the front end of the material fastener.

FIG. 20 is a fragmentary section of a rear view showing the top portion of the ends of the opposed faces of the louver along with the top portion of the curtain wall section being secured within the front end of a material fastener having a sufficient length, and curtain wall section having an upper hem (lower hem not showing) while the opposed faces of the louver are connected together along a vertical seam.

FIG. 21 is a fragmentary isometric view showing two adjacent louvers in open position along with the curtain wall sections secured within the material fasteners at their entire length.

FIG. 22 is a fragmentary isometric view similar to FIG. 21 with the louvers in a retracted position.

FIG. 23 is a front side view showing a plurality of rectangular strips of semi opaque fabric attached to a plurality of rectangular strips of transparent material along vertical seams.

FIGS. 24 and 25 shows perspective and topside views respectively of a continuous assembly of alternating semi opaque lopped louvers and transparent material sections.

FIGS. 26 and 27 show front side views of actual colored photocopy of the first embodiment in accordance with the present invention, in an open and closed position respectively.

FIGS. 28 and 29 show perspective and topside views respectively of a first arrangement of the second embodiment of the present invention.

FIG. 30 is an enlarged fragmentary section taken along line 30-30 of FIG. 29.

FIGS. 31 and 32 show perspective and topside views respectively of the second arrangement of the second embodiment of the present invention. FIG. 32 shows the distance C 10 along line 29-29 of FIG. 29.

### DESCRIPTION OF THE REFERENCED NUMERALS

Turning now descriptively to the drawings, in which similar reference characters denote similar elements throughout the several views. The figures illustrate the window curtain covering of the present invention, with regard to the reference numerals used; the following numbering is used throughout the various drawing figures.

### First Embodiment

38 window curtain covering
40 louvers
C curtain wall sections
42 loop
44 distal end of the loop
46 pocket
D₁ width of the louver
D₂ width of curtain wall sections
S seam
48 shaping means
50 hole
52 hook
54 track
56 brackets
F window frame
58 mechanisms
60 elongated cable
W wall
T material fastener
B back wall
A₁ first wall
A₂ second wall
M seam
N thin slat
H upper hem
P₁ strips of first sheet
P₂ strips of second sheet
D width of strip P1
S₁ seam
S₂ seam
138 window curtain covering
C₁₀ curtain wall sections between adjacent loops
C₂₀ curtain wall sections between opposed faces of the loops
142 loop
144 distal end of the loop
146 pocket
D₃ width of curtain wall sections
D₄ distance between opposed faces of the loop
D₅ width of the opposed faces of the loop
E seam
148 shaping means
238 window curtain covering
C₃₀ curtain wall sections between adjacent loops
C₄₀ curtain wall sections between opposed faces of the loops
150 hole
162 loop
164 distal end of the loop
166 pocket
D₃₀ width of curtain wall sections
D₄₀ distance between opposed faces of the loop
D₅₀ width of the opposed faces of the loop

### DETAILED DESCRIPTION OF THE PREFERRED EMBODIMENT

The following discussion describes in detail two embodiments of the invention and several variations of these embodiments. This discussion should not be construed. However, as limiting the invention to those particular embodiments, practitioners skilled in the art will recognize numerous other embodiments as well. For definition of the complete scope of the invention, the reader is directed to appended claims.

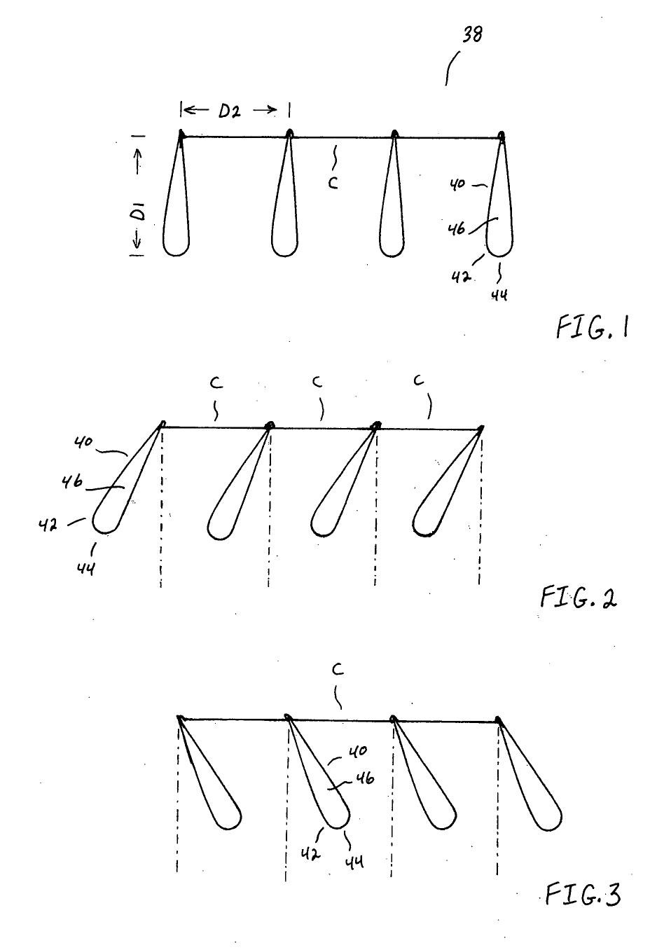

Turning now descriptively to the drawings in which similar reference characters denote similar elements throughout the several view. FIGS. 1 through 7 illustrate the first embodiment of the window curtain covering assembly of the present invention indicated generally by the numeral 38 and consists of a combination of a series of parallel regularly spaced louvers 40 made of semi opaque, or opaque flexible fabric material such as woven, non-woven, knitted, or stitched bonded fabric, and curtain wall sections C made of transparent or translucent flexible material such as sheer cotton, sheer nylon, lace, thermoplastic and combinations thereof. The louvers 40 and curtain wall sections C having the same length.

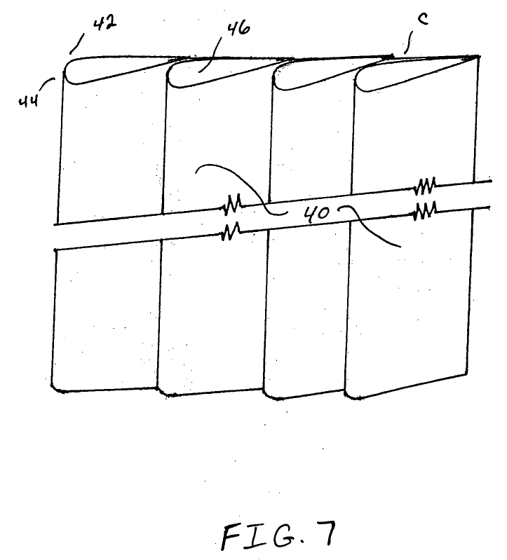

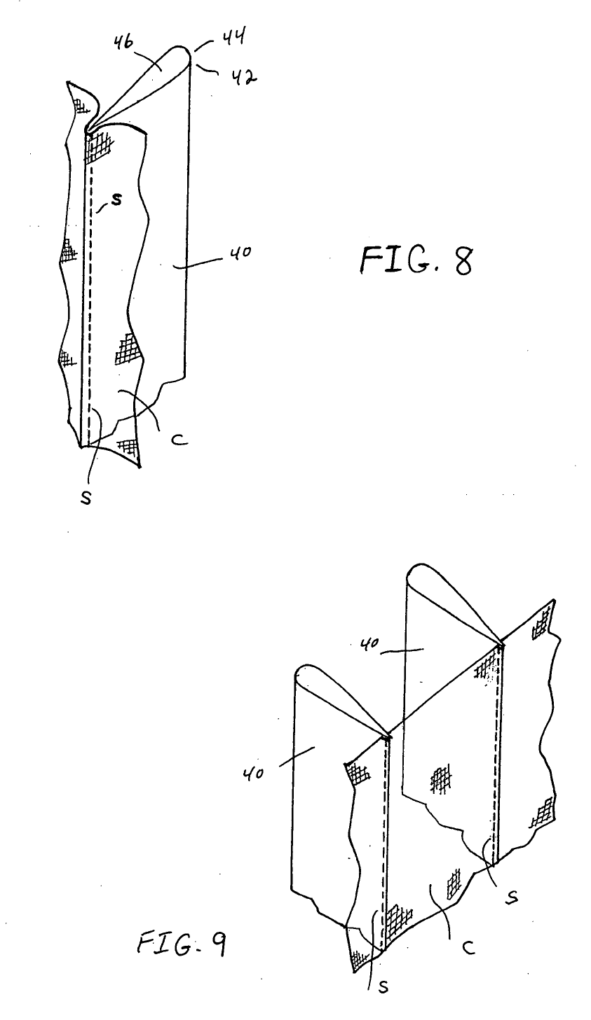

The louvers 40 having a width designated D₁ measured from the curtain wall sections C to the distal end of the loop 44 and is about the same or greater than the distance between adjacent louvers designated D₂ as shown in FIG. 1 such that each louver overlaps a subjacent louver when the curtain 38 is in the closed position as shown in FIGS. 4 and 7. In this position the louvers 40 which are made of semi opaque fabric overlapping each other will decrease the transmission of light through to the room, and when the louvers made of opaque fabric will substantially block the transmission of light through to the room.

In the open position of curtain 38 shown in FIGS. 1 and 6 the curtain wall sections C limits the space between adjacent louvers 40 by the distance D₂ and is completely visible which permitting the transmission of light through the room, in this position the louvers 40 and the curtain wall sections C are arranged in relation to one another as to form a combination of continuous assembly of alternating louvers 40 and curtain wall sections C respectively.

For closing the curtain 38 the louvers 40 may be moved either to the left FIG. 2 or to the right FIG. 3 from the open position shown in dot-and-dash lines, so that they will then occupy a position in which the curtain 38 is half open or half closed respectively.

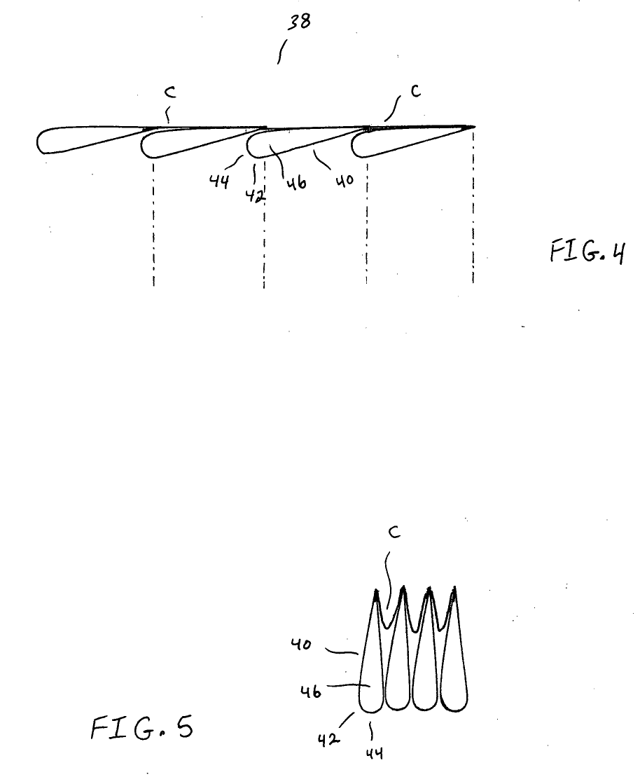

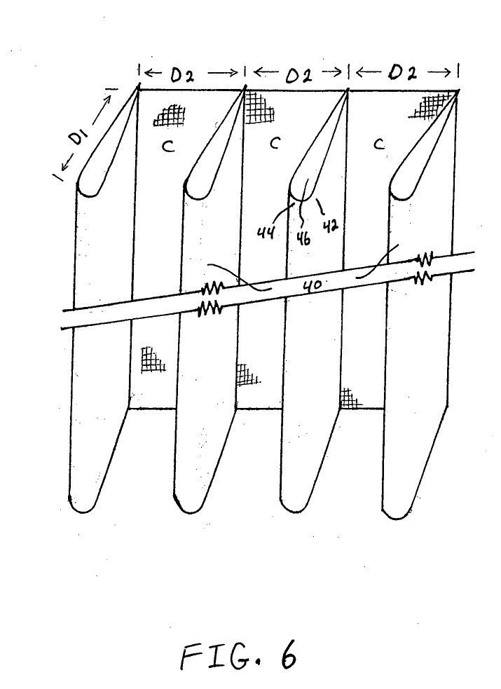

With the louvers 40 in the open position shown in FIG. 1 the entire curtain 38 can be retracted in the known manner as shown in FIG. 5 to form a stack of louvers, in this position the curtain wall sections C are completely concealed by the louvers.

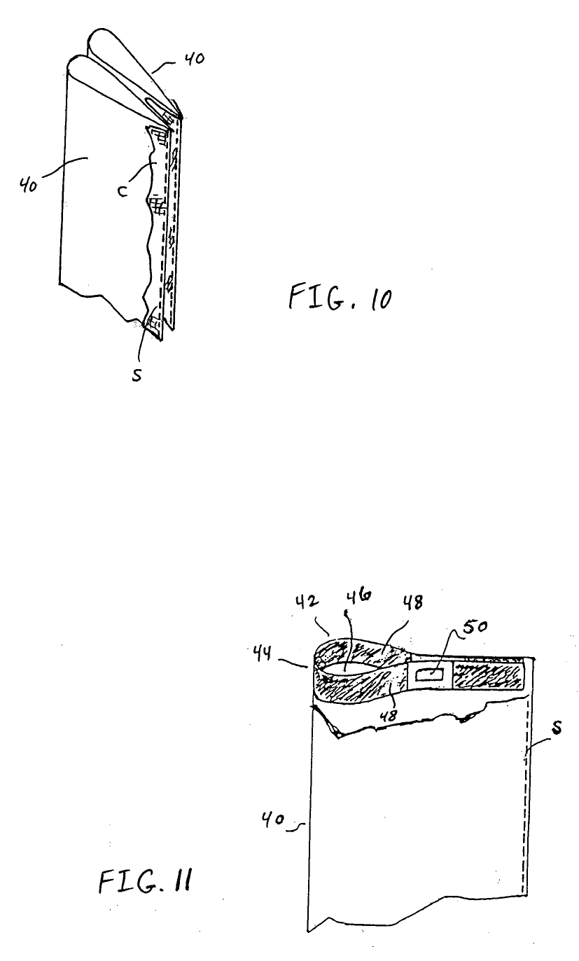

FIG. 8 shows a louver 40 being independently formed by folding a strip of the semi opaque or opaque flexible fabric material back upon itself longitudinally so as to define a single loop 42 that extends from one side only of the curtain wall section C and opposed faces of each loop are connected together with the curtain wall sections along vertical seam S parallel to and spaced from the distal end 44 of the loop 42 to form a pocket 46 in the loop.

The seams S preferred to run from behind the curtain wall sections C, by doing that the curtain wall sections will curve forwardly between the adjacent louvers 40 as shown in FIG. 9.

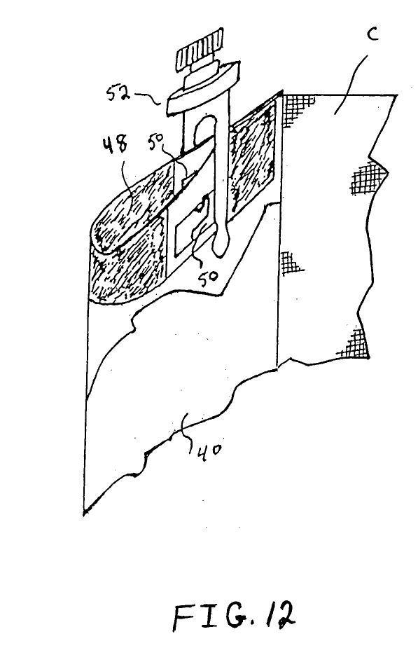

When the entire curtain 38 moved to the retracted position in the known manner to form stack of louvers 40, in this position the curtain wall sections C are curved forwardly and completely concealed by the louvers 40 as shown in FIG. 10.

The seams S can be formed in any desired manner, for example by ultrasonic welding when the curtain wall sections C is formed of synthetic fibers or a blend of synthetic and natural fibers, or by heat sealing if the curtain wall sections is formed of a thermoplastic material. The seams can also be formed by use of suitable adhesive or by sewing. However, the practitioners skilled in the art will recognize the suitable right way to form the seams.

FIG. 11 is showing a shaping means of thin strip of plastic material 48 having sufficient width and is formed with a single loop by folding the strip of plastic upon itself width wise. Thus defining opposed faces made smaller than the opposed faces of the loop 42 so it can be attached to the inner edge of the top portion of the pocket 46 by using adhesive (shows as a shaded area) and end before the seam S to allow the passage of the stitches or adhesive to go through to the top end of the louver 40.

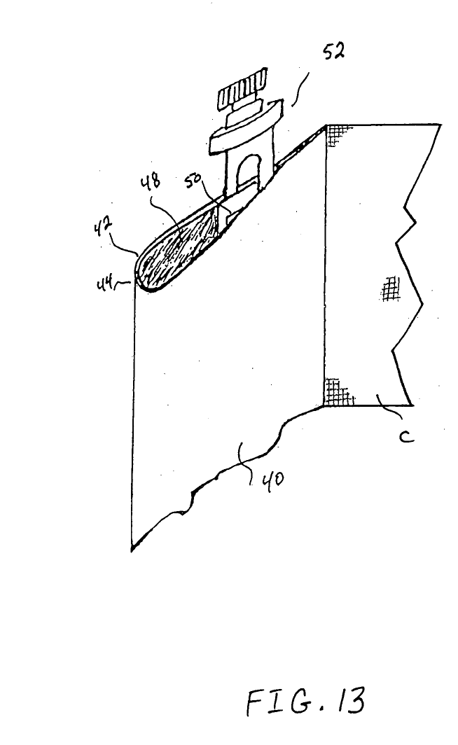

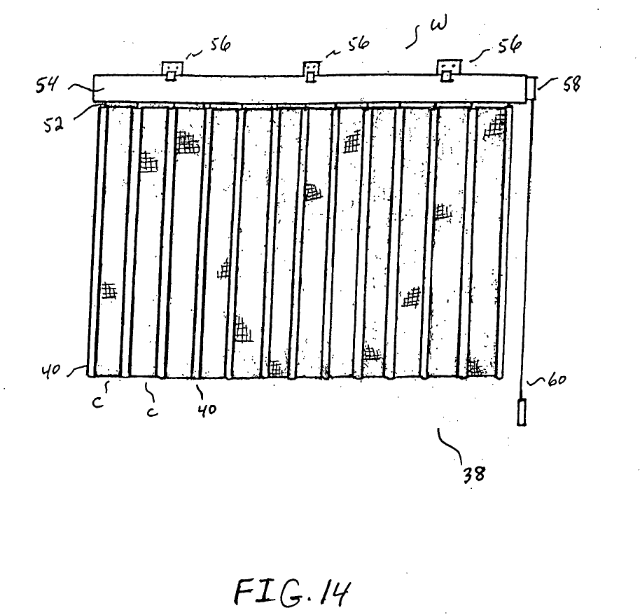

The thin strips of plastic 48 having a hole 50 in about the central of there opposed faces and can conveniently be formed in the opposed faces by punching. The area around the hole 50 left unattached (shows as non shaded area) to allow for the hook 52 to be adapted to the hole as shown in FIG. 12 so that the thin strip 48 and the bottom portion of the hook 52 are hidden inside the pocket 46 as shown in FIG. 13. The shaping means 48 also can be attached to the pocket 46 by making a hem in the inner upper end of the loop 42 by extending the material in length at the upper end and then folding the extension back upon itself to keep the louvers 40 and curtain wall sections C at the same length. Then insert the shaping means 48 into the hem and make holes in the inner part of the hem so it will fit over the holes 50 in the shaping means. The hem could be stitched or glued.

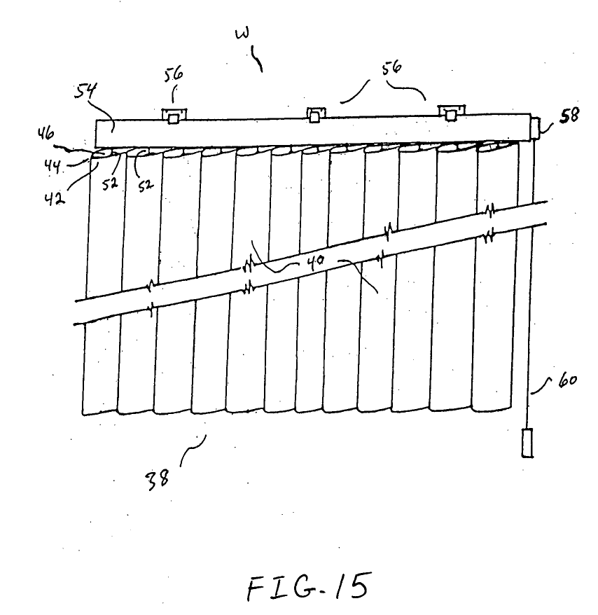

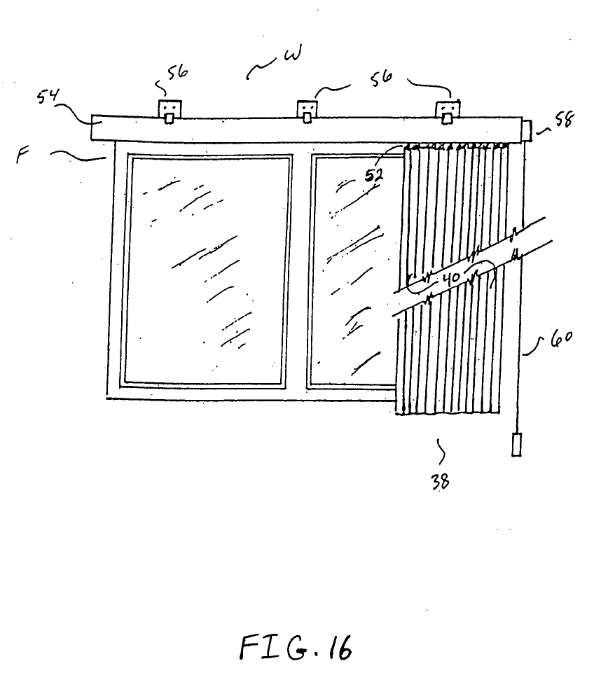

FIGS. 14, 15, and 16 are showing the louvers 40 in the curtain 38 suspended in a track 54 anchored horizontally to wall W by brackets 56 located above the top of the window frame F. The track 54 contain a number of sliding carriers (not showing) together with a mechanism 58 that can be controlled in the conventional fashion by elongated cable 60 for shifting the louvers to their various positions opened, closed and retracted positions respectively. Each carrier having a hook 52 adapted to extend downwardly from the carrier. The carriers (not showing) and the shifting mechanisms are well-known in the art and do not constitute a part of the present invention.

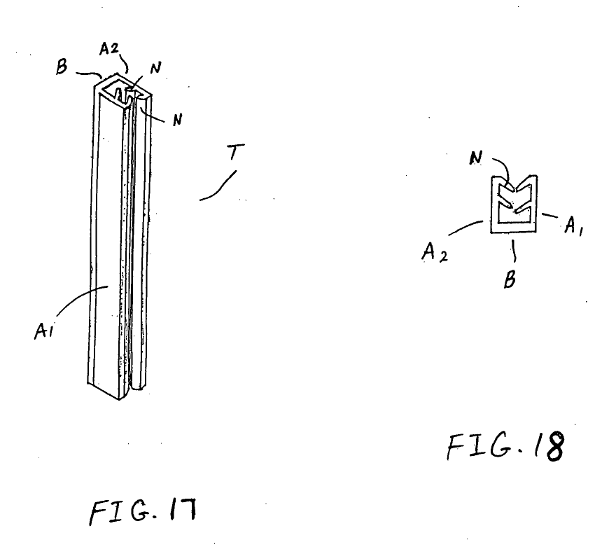

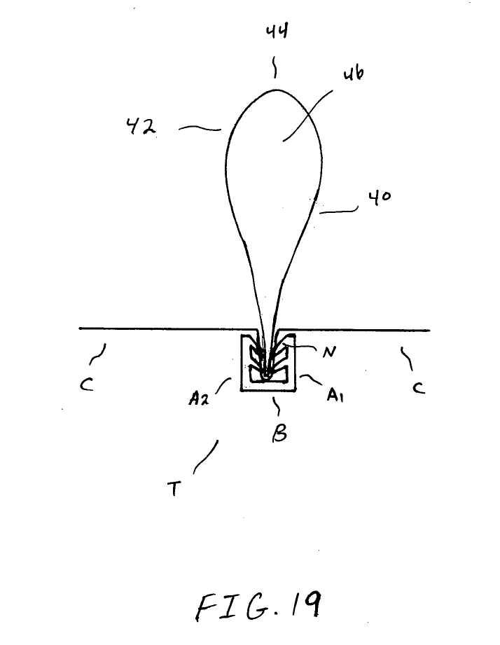

FIGS. 17 and 18 showing a perspective view and an end elevational view for the material fastener respectively. The material fastener T includes a back wall B, a first wall A₁ and a second wall A₂. The first wall A₁ and the second wall A₂ are parallel to each other and are spaced apart. They protrude from the back wall B. The material fastener T further include one or more thin slats N which extend from inside surfaces of the first and second walls A₁ and A₂ of the material fastener T. The thin slats N can be inwardly angled and preferably overlap each other to firmly secure the opposed faces of the louvers 40 along with the curtain wall sections C as shown in FIG. 19. Preferably the material fastener T is made of a more rigid thermoplastic and the thin slats N are made of a more resilient thermoplastic.

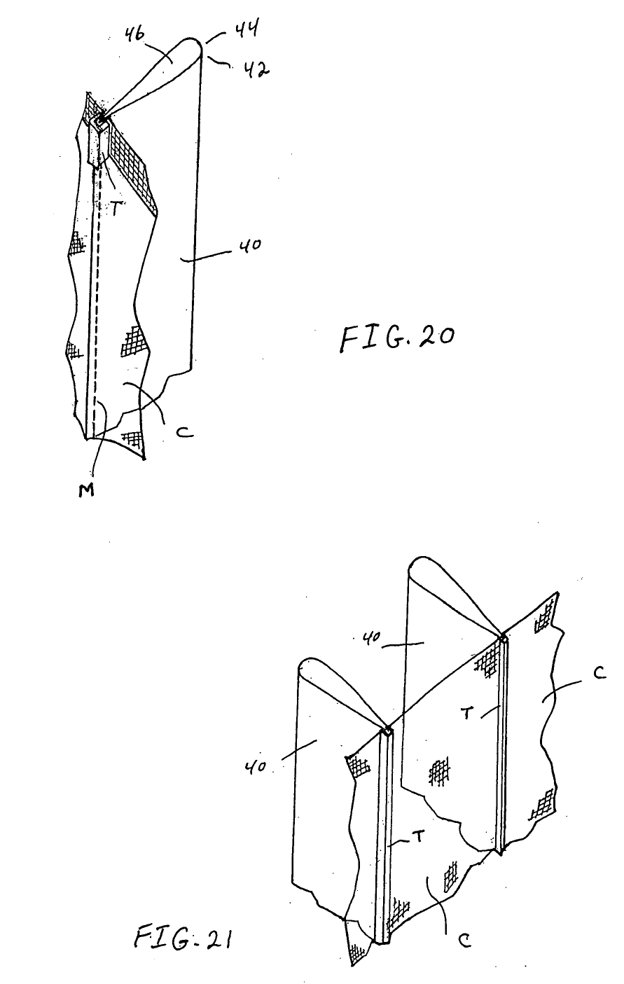

FIG. 20 shows a louver 40 being independently formed by folding a strip of the semi opaque or opaque flexible fabric material back upon itself longitudinally so as to define a single loop 42 that extends from one side only of the curtain wall section C and opposed faces of the loop are connected together along a vertical seam M parallel to and spaced from the distal end 44 of the loop 42 to form a pocket 46;

The curtain wall section C and louver 40 secured at their top portion only within a material fastener T having a sufficient length.

In this arrangement the upper end of the curtain wall section C is preferably folded over upon itself and stitched, bonded along its entire face to provide a hem having the same length as the material fastener, to help maintain and stiffen the outward facing. Also the lower end of the curtain wall section C could be folded over upon itself and stitched, bonded along its entire face to provide a bottom hem (not showing).

The seams M can be formed in any desired manner. For example by ultrasonic welding or by bonding the seams can also be formed by use of suitable adhesive or by sewing. However, the practitioners skilled in the art will recognize the suitable right way to form the seams.

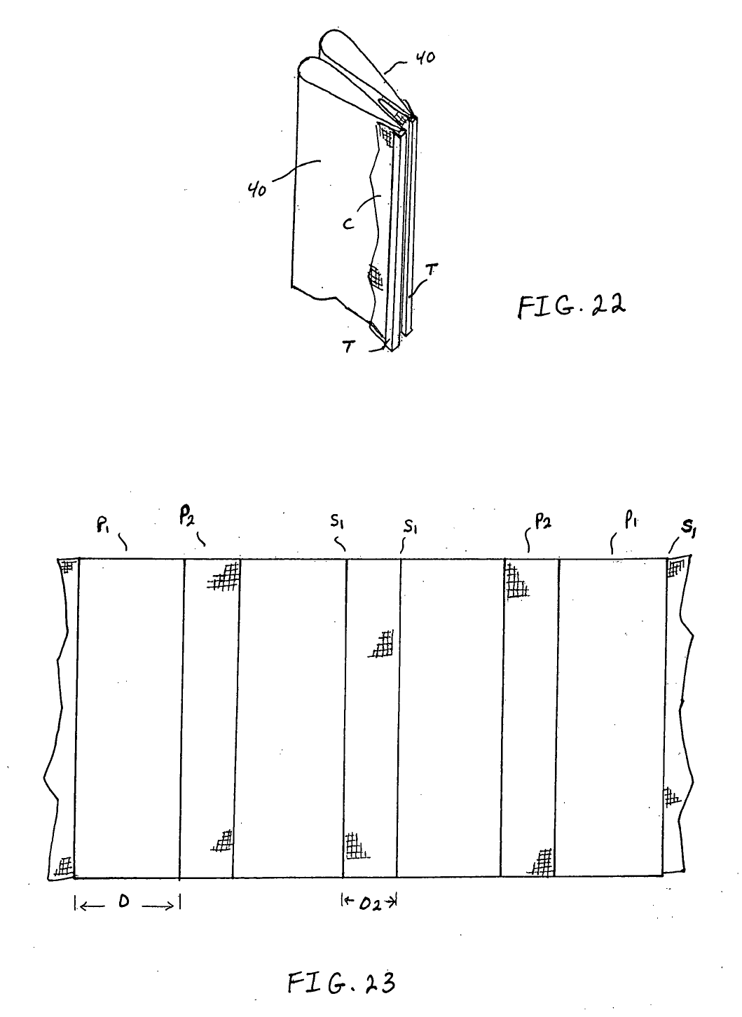

FIG. 21 shows two adjacent louvers 40 in open position along with curtain wall sections C secured within material fasteners T respectively along their entire length. The thin slats N firmly secure the louver 40 and the curtain wall section C and retard there removal, by securing the louvers 40 and the curtain wall sections C within the material fasteners T, the curtain wall sections C will curve forwardly between the adjacent louvers. When the entire curtain 38 moved to the retracted position in the known manner to form stack of louvers 40, in this position the curtain wall sections C are curved forwardly and completely concealed by the louvers 40 as shown in FIG. 22.

FIGS. 23-25 showing the two sheets of flexible fabric material divided to a plurality of strips having the same length.

First strips made of semi opaque or opaque fabric P₁.

Second strips made of transparent or translucent P₂.

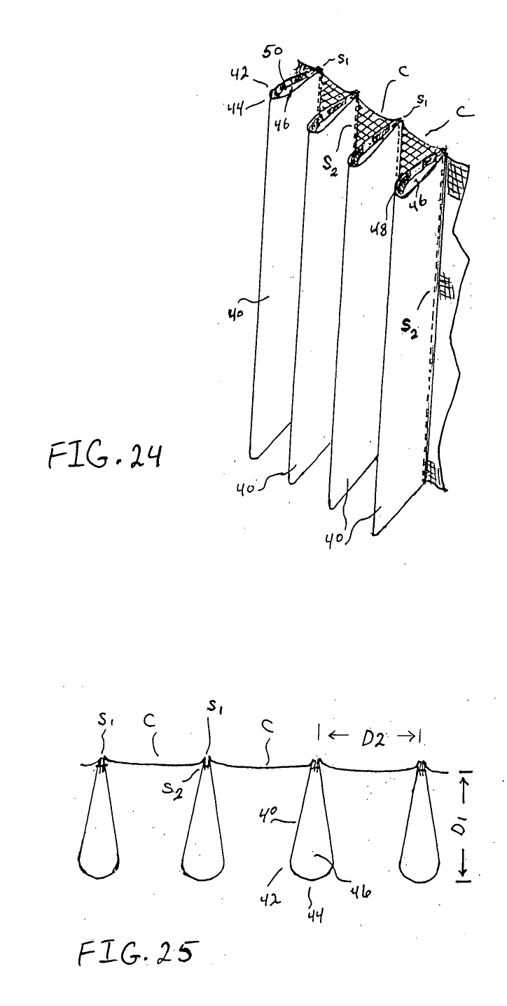

The strips of first sheet having a width designated D is about double or greater than the width of the strips of second sheet (curtain wall sections C) designated D₂ as shown in FIG. 23. and by providing one strip of first sheet and positioning it so that the left edge portion and right edge portion overlaps the adjacent edge portions of strips of second sheet longitudinally and doing this with repetition and by attaching them together along vertical seam S₁ along the length of the overlapping of adjacent portions as to define a combination of continuous assembly of alternating semi opaque or opaque strips and transparent or translucent strips. By folding the strips of first sheet P₁ upon themselves longitudinally so as to define single loops 42 that extend from one side only of the strips of second sheet P₂ (serve as curtain wall sections C) and opposed faces of each loop are connected together along vertical seam S₂ parallel to and spaced from the distal end 44 of the loop to form a pocket 46 in each loop (P₁ will serve as louvers 40) as shown in FIG. 24. The edges of seam S₁ is inserted between the opposed faces of the loop 42 so the seam S₂ will hide the edges of seam S₁ to give a clean and finish look for the window curtain covering 38. The curtain wall sections C limits the space between adjacent louvers 40 by the distance D₂ as shown in FIG. 25.

The seams S₁ and S₂ can be formed in any desired manner as the examples mentioned here before.

The strips P₁ and P₂ could be pre fabricated of pre selected colors and designs to ease the production of the present invention of window curtain covering 38.

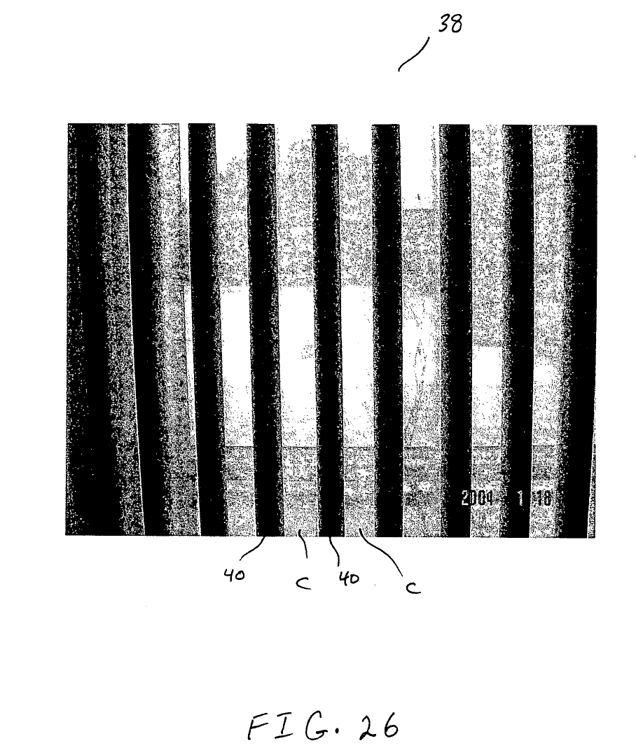

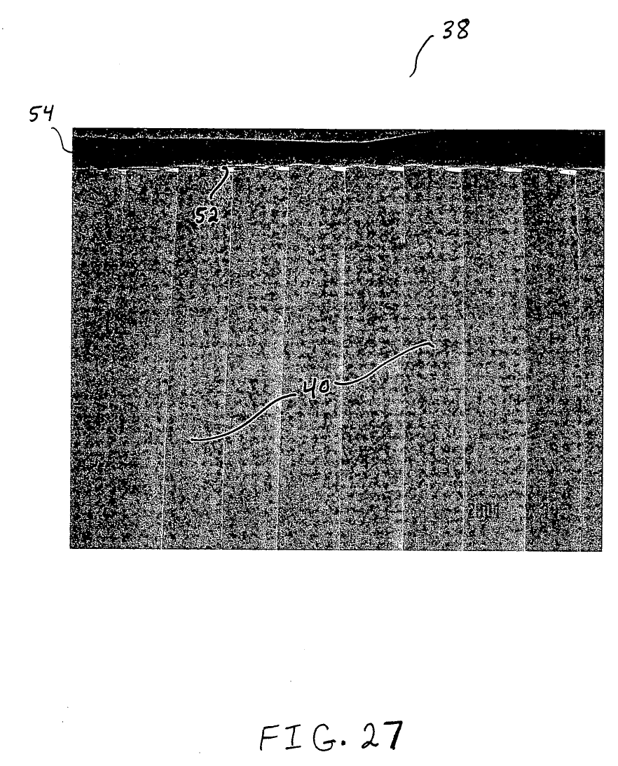

FIGS. 26 and 27 is actual colored photocopy of the first embodiment in accordance with the present invention in an open and closed position respectively. It shows the louvers 40 in the curtain 38 suspended in a track 54 anchored horizontally to wall (not showing). The tracks 54 contain a number of sliding carriers (not showing). Each carrier having a hook 52 adapted to extend downwardly from the carrier.

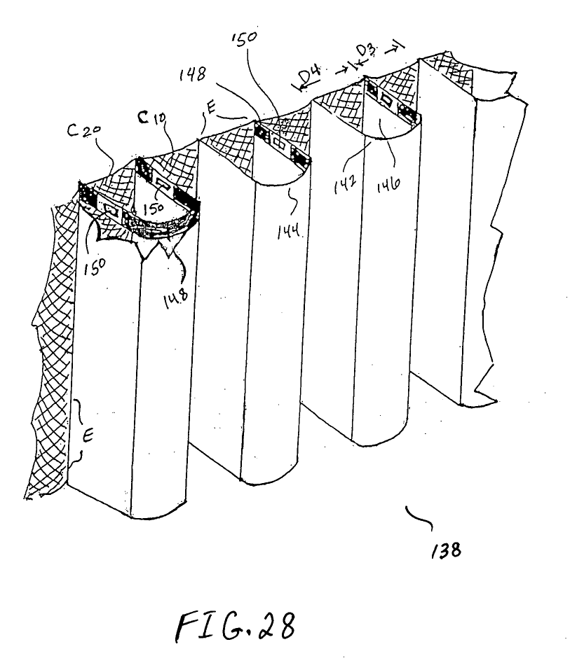

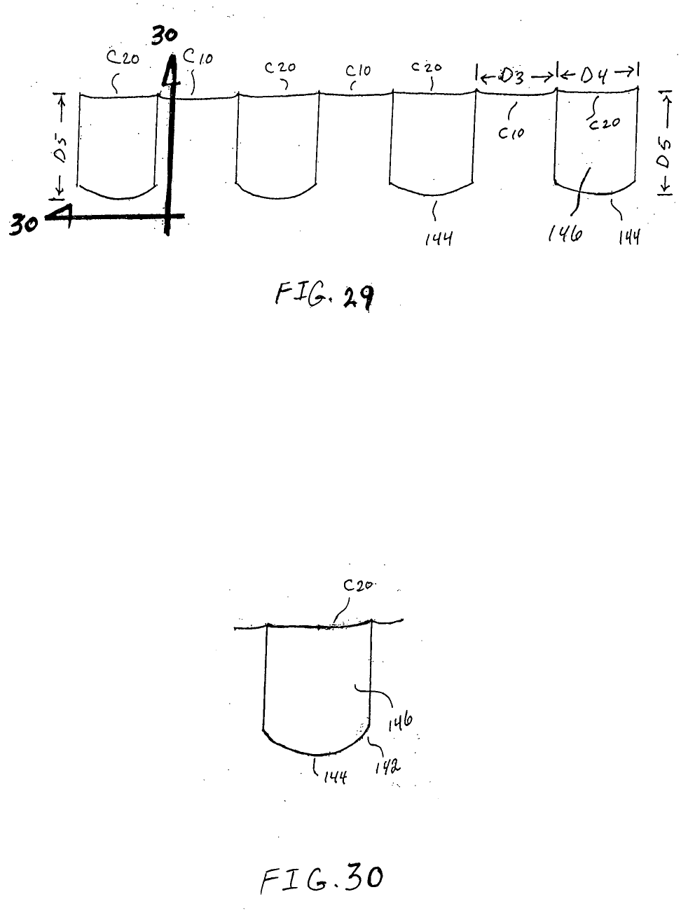

Second Embodiment of the present invention which the window curtain covering 138 is formed with a U-shape loop, as shown in FIGS. 28-30 where in, the semi opaque or opaque fabric strips are about three times larger in width than the transparent or translucent curtain wall sections C₁₀. In this arrangement the semi opaque or opaque strip folded upon itself to form a loop 142 and the opposed faces of the loop is parallel to each other and having shaping means of thin strip of plastic having holes 150 in the top portion of each side of it and in about the central of its sides.

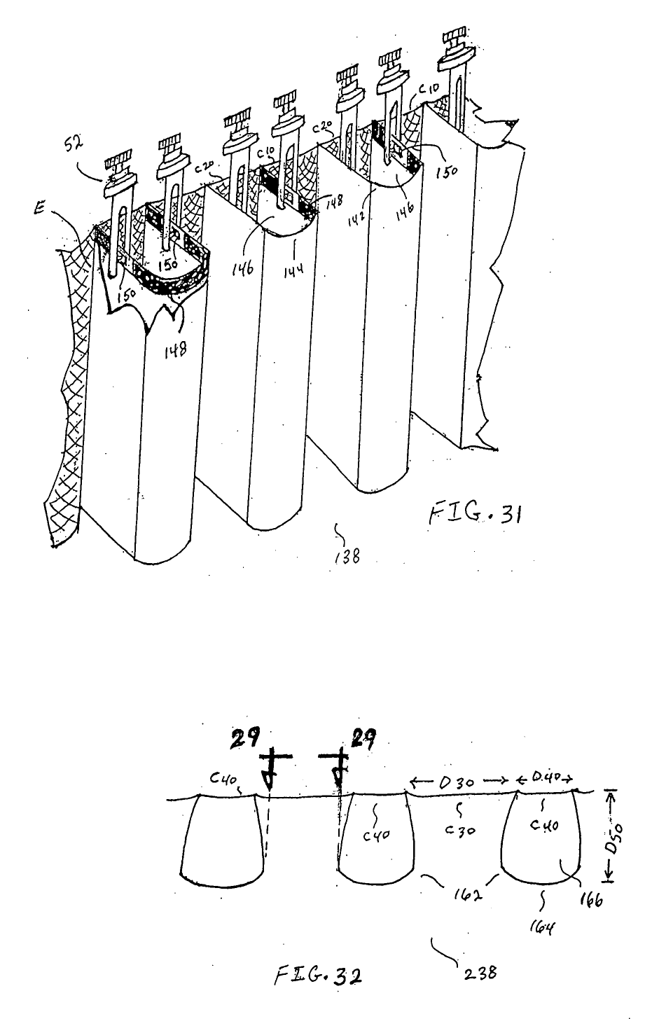

The opposed faces of the loop 142 being attached to the transparent or translucent material along vertical seams E a pre selected distance D₄ which keeps the opposed faces of the adjacent loops always parallel to each other and to form curtain wall sections C₂₀ between the opposed faces of each loop, also forming a pocket 146 in the loop. The curtain wall sections C₁₀ will limit the space between adjacent loops 142 by the distance D₃ which is about the same width as the width of the opposed faces of the loops D₅ which measured from the curtain wall section C₁₀ to the distal end 144 of the loop. Each side of the loop 142 adapted to hang vertically from adjacent hooks 52 in FIG. 31.

FIG. 32 shows the curtain wall sections C₂₀ being narrowed down to C₄₀ so the distance D4 in FIG. 29 became less to a pre selected distance D₄₀ which makes the opposed faces of the loop 162 more closer to each other. In this condition the curtain wall sections C₁₀ shown in FIG. 29 will increase in width to C₃₀ which is shown in FIG. 32. This will increase the transmission of light through the room when the curtain is in open position. By doing that the distance D₃ and D₄ added together in FIG. 29 will remain the same as the distances D₃₀ and D₄₀ added together in FIG. 32.

1. A window curtain covering assembly, comprising in combination a series of parallel regularly spaced louvers made of strips of semi opaque, or opaque flexible material and a single sheet of transparent or translucent material, said louvers formed with a single loop by folding said strips upon themselves longitudinally, thus defining opposed faces for said loop, said sheet of transparent or translucent material having the same length of said louvers and forms curtain wall sections behind adjacent louvers, which by positioning said louvers so that the loops extending from one side only of said curtain wall sections with said opposed faces of each loop connected together with said curtain wall sections along vertical seams parallel to and spaced from the distal end of said loops to form a pocket in each loop, said seams of adjacent loops being horizontally spaced apart a pre selected distance along the entire face of said curtain wall sections which limits the space between adjacent louvers when curtain assembly is in open condition and forms a continuous assembly of alternating semi opaque or opaque louvers and transparent or translucent curtain wall sections. The loop extension measured from the curtain wall section to the distal end there of, being about the same or greater than said pre selected distance along said face of the curtain wall sections, the louvers being adapted to hang forwardly from said curtain wall section and having a width such that each louver overlaps a subjacent louver when the curtain assembly is in closed condition.

2. A window curtain assembly as defined in claim 1, where in said louvers having a shaping means of thin strip or batten of plastic material having sufficient width, said thin strip formed with a single loop by folding the material upon itself width wise, thus defining opposed faces, said opposed faces having a hole in about the central of each of them, and by attaching said thin strip to at least the top portion of the inner of said pocket of said louvers leaving the central of said opposed faces unattached to permit passage of the hanging means there through and giving the louvers substantially looped shape and an appearance of vertical louvers.

3. A window curtain assembly as defined in claim 2, wherein said louvers extended vertically and being pivotally mounted to a horizontal track having a plurality of sliding carriers, each carrier having a hook extended downwardly from said carrier and adapted to said holes in the central of said opposed faces of said thin strips of plastic in each louver so that when curtain is open it forms a continuous assembly of alternating semi opaque or opaque louvers and transparent or translucent curtain wall sections.

4. A window curtain assembly as defined in claim 1, wherein said louvers are made of a woven, non woven, knitted, or stitched bonded fabric.

5. A window curtain assembly as defined in claim 1, wherein said curtain wall section is selected from the group consisting of sheer cotton, sheer nylon, lace thermoplastic and combinations thereof.

6. A window curtain assembly as defined in claim 1, where in an upper end of said curtain wall section is folded over upon itself and stitched, bonded along its entire face to provide a hem.

7. A window curtain assembly as defined in claim 1, where in a lower end of said curtain wall section is folded over upon itself and stitched, bonded along its entire face to provide a hem.

8. A window curtain assembly as defined in claim 1, wherein said louvers are made of a variety of colors and or designs.

9. A window curtain assembly as defined in claim 1, wherein said louvers are attached to said curtain wall sections by bonding.

10. A window curtain assembly as defined in claim 1, where in said opposed faces of said louver connected together along a vertical seam, while said curtain wall section are attached to said louver by a material fastener having the same length of said louver and curtain wall section, said material fastener having a top end and a bottom end Being a mirror image thereof;

11. A window curtain assembly as defined in claim 10, wherein said material fasteners having a sufficient length to attach said curtain wall sections to said louvers at their top portions.

12. A window curtain assembly as defined in claim 10, wherein said material fastener made of rigid plastic material comprising:
a back wall,
a first wall and a second wall, which are spaced apart, protruding from said back wall, said first and second wall having at least one thin slat in each of them made of plastic extending inwardly from an inside surface of each of said first and second wall, said at least one thin slat on each wall being inwardly angled with the thin slats overlapping to secure the opposed faces of the louver along with the curtain wall section within said material fastener.

13. A window curtain assembly as defined in claim 1 comprising in combination:
a) first sheet of semi opaque or opaque flexible material and a second sheet of transparent or translucent material, said first sheet and second sheet divided into a plurality of rectangular strips having the same length, said strips of said first sheet having about double or greater the width of said strips of said second sheet.
b) providing the pieces of said first sheet and positioning them to overlap the edge portions of the strips of said second sheet so that the edge portions of the strips of said first sheet overlaps the adjacent edge portions of the strips of said second sheet.
c) By attaching all the strips of said first and second sheets together along the length of the overlapping portions of adjacent strips so that the strips form a continuous assembly of alternating semi opaque or opaque and transparent or translucent strips.
d) said strips of said first sheet formed with a single loop by folding the strips upon themselves longitudinally, thus defining opposed faces for each loop extending from one side only of said strips of said second sheet and by attaching the opposed faces of each loop together along a vertical seam and by doing that the edge portions of the strips of said second sheet always being hidden in between the opposed faces of said loops. Said seams are parallel to and spaced from the distal end of said loop to form a pocket in each loop, said seams of adjacent loops being horizontally spaced apart by a distance equal to the width of the strips of said second sheet, said loops are arranged to serve as louvers and said strips of said second sheet are arranged to serve as curtain wall sections between the adjacent louvers.

14. A window curtain covering assembly comprising in combination a series of parallel regularly spaced loops made of strips of semi opaque or opaque flexible material and a single sheet of transparent or translucent material, said loops formed with a U-shape by folding the strips upon themselves longitudinally. Thus defining opposed faces parallel to each other for each loop, said transparent sheets having the same length of said loops and forms a curtain wall section behind the adjacent loops, which by positioning said parallel opposed faces for each loop so that the loops extending from one side only of said curtain wall sections with said parallel opposed faces of each loop connected separately with said curtain wall section along vertical seams parallel to and spaced from the distal end of said loops to form a pocket in each loop, said seams of adjacent loops being horizontally spaced apart a pre selected distance along the curtain wall section which limits the spacing between adjacent loops when curtain assembly is in open condition and forms a continuous assembly of alternating semi opaque or opaque U-shape loops and transparent or translucent curtain wall sections. The loop extension measured from the curtain wall section to the distal end there of being about the same or greater than said pre selected distance between the adjacent loops along the curtain wall section. The opposed faces for each loop being adapted to hang forwardly from said curtain wall section and having a width such that each loop over laps a subjacent loop when curtain assembly is in closed condition.

15. A window curtain assembly as defined in claim 14, where in said opposed faces of each loop having a pre selected distance between them so as to keep them parallel to each other.

16. A window curtain assembly as defined in claim 14 wherein said pre-selected distance between opposed faces of each loop made smaller to narrow the spacing between them and increase the width of said curtain wall sections, which increasing the space between the adjacent loops to allow for more lights to pass through the curtain wall sections into the room.

17. A window curtain assembly as defined in claim 14, wherein said loops having a shaping means of thin strip or batten of plastic material having sufficient width, said thin strip formed with a single loop as to define a U-shape by folding the material upon itself width wise, thus defining opposed faces parallel to each other, said opposed faces having a hole in about the central of each of them and by attaching said thin strip to at least the top portion of the inner of said pocket of said loops leaving the central of said opposed faces un attached to permit passage of the hanging means there through and giving the loops substantially U-shape.

18. A window curtain assembly as defined in claim 14, wherein said opposed faces of said loops extended vertically and being pivotally mounted to a horizontal track having sliding carriers. Each carrier having a hook extended downwardly from said carrier and adapted to said hole in the central of one side of said thin strip of plastic and the adjacent hook adapted to the hole in the central of the other side of said thin strip of plastic in each loop so that when curtain is open it forms a continuous assembly of alternating semi opaque or opaque U-shaped loops and transparent or translucent curtain wall sections.

19. A window curtain assembly as defined in claim 14, wherein said loops and curtain wall sections made of the afore mentioned in claims 4 and 5.
